(19) United States
(12) Patent Application Publication
(10) Pub. No.: US 2017/0238124 A1
(43) Pub. Date: Aug. 17, 2017

(54) Skateboard Riser With Integrated Bluetooth Speaker

(71) Applicant: Travis Anderson, Redondo Beach, CA (US)

(72) Inventor: Travis Anderson, Redondo Beach, CA (US)

(21) Appl. No.: 15/045,528

(22) Filed: Feb. 17, 2016

(51) Int. Cl. H04W 4/00; H04R 1/02; A63C 17/26; H04W 76/02; H04W 4/02

(52) U.S. Cl. CPC H04W 4/008; H04W 76/023; H04W 4/021; A63C 17/26; H04R 1/028; A63C 17/01

(57) ABSTRACT

A riser for a skateboard with an integrated Bluetooth transceiver, the riser attaching between the deck and truck of the skateboard. Wireless transfer of information from device to device, such as between a mobile phone and the riser, is enabled. The output signal from the transceiver is coupled to a digital audio amplifier for providing an audio signal to persons within the listening area of the riser.

### BACKGROUND OF THE INVENTION

1. Field of the Invention

The present invention provides a skateboard riser configured to support a Bluetooth transceiver.

2. Background of the Invention

For many years, the basic components of a skateboard have remained the same. A skateboard is made up of a deck, axle assembly and wheel assembly. A riser has been added to these, the risers being used as a spacer between the deck and the truck assemblies to offset the wheels from the deck by increasing the height of the board off the ground.

Typically risers have been made of solid plastic in the shape of a square or rectangle. However, a number of efforts have been made to provide a riser that has been hollowed out such that various components could be supported therein.

U.S Publication No. US 2003/0201620A1 to Seelye discloses a skateboard riser designed to support a light source therein.

U.S. Publication No. US 2009/0236811A1 to Lewis discloses a riser for a skateboard with an integrated LED light.

U.S. Pat. No. 4,824,139 to Robbins discloses a skateboard having an audio entertainment device mounted to the lower surface of the skateboard between the rearward truck and a tailskid plate. An elastic spacer 26 (similar in functionality to a riser), is apparently a solid and positioned adjacent the audio entertainment device.

Bluetooth® is a wireless technology that enables data to be exchanged over short distances form fixed or mobile devices. The Bluetooth system, in essence, comprises a transmitter and receiver set. Many such systems comprises a user with head phones and a mobile phone, the mobile phone typically transmitting music to a separate speaker device wirelessly.

What is desired is to provide a skateboard user that has a Bluetooth system incorporated therein and designed to be strong enough to support the weight of a skateboard rider as well as normal impacts incurred while skateboarding.

### SUMMARY OF THE INVENTION

The present invention provides a skateboard riser that is configured to receive a Bluetooth transceiver. The transceiver, when activated, wirelessly connects with an appropriately configured “master” device whereby the skateboard user can, for example, listen to music emanating from the “slave” device.

### DESCRIPTION OF THE DRAWINGS

For a better understanding of the present invention as well as other objects and further features thereof reference is made to the following description which is to be read in conjunction with the accompanying drawing therein:

FIG. 1 is an exterior view of a conventional skateboard showing placement of the skateboard riser which incorporates the Bluetooth technology in accordance with the teachings of the present invention;

FIG. 2 shows the internal area of the riser case with the components necessary to enable a Bluetooth transceiver to be activated;

FIG. 3A illustrates the internal portion of the riser without any components mounted therein and FIG. 3B is a side view of the case illustrating the thru holes;

FIG. 4 is a perspective view of the underside of the skateboard assembly illustrating the mini-USB female socket and the Bluetooth power switch; and

FIG. 5A illustrates a Bluetooth transceiver board used in the present invention and FIG. 5B is a perspective view showing the arrangement of components within the riser.

### DESCRIPTION OF THE INVENTION

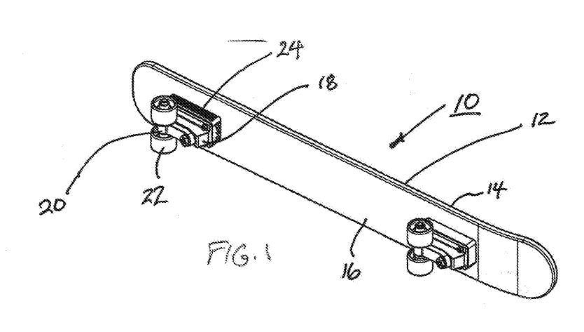

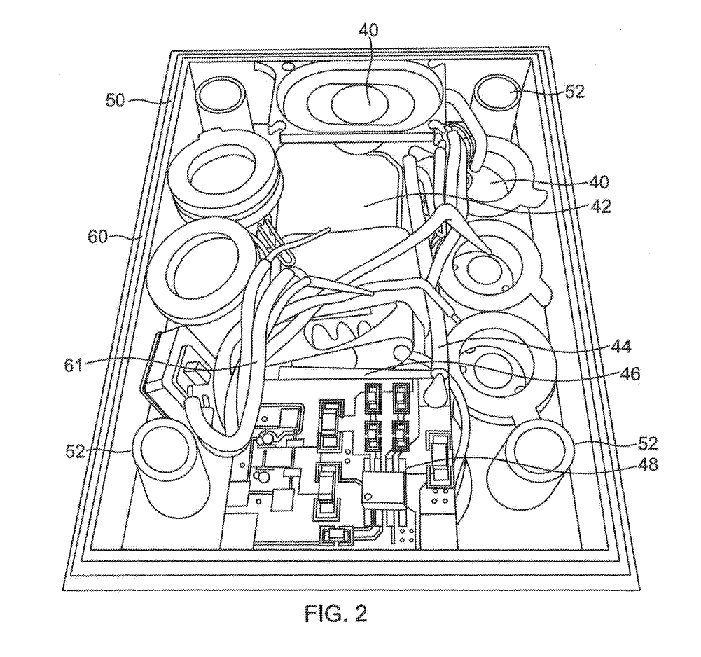

Referring now to FIG. 1, there is shown a typical skateboard assembly 10, which comprises a deck 12 with an upper surface 14 and a bottom surface 16, truck assembly 18, which comprises a baseplate (not shown), the upper surface of the baseplate in truck assembly 18 being in contact with the bottom surface 16, an axle 20 and wheels 22 (the wheel bearings and wheel nuts are part of the truck assembly but not shown in the figure). The skateboard riser 24 and the truck assembly are mounted to the deck 12 in a conventional manner.

Referring now to FIG. 2, the internal portion of riser 24 is illustrated and the components of riser 24 and the functions thereof are described as follows:

Speakers 40 function to take the information from the digital amplifier, via speaker connection wire, and create vibrations in such a manner that produces audio frequencies which people interpret as music.

Lithium-Ion Battery 42 functions to provide electrical power to the system.

Power Wire 44 transfers charge between components.

Digital Amplifier Printed Circuit Board (PCB) 46 takes the initial, analog signal/information received by a Bluetooth transceiver and converts it to a digital signal which is connected, in turn, to speakers 40.

Lithium Battery charging PCB 48 converts the incoming current to the appropriate current for the battery 42 as well as the USB female socket 52 (FIG. 2) via electrical/power wiring 44.

Bluetooth Transceiver PCB 50 allows a secure connection to share information with any other device containing an appropriate Bluetooth module. This permits the wireless transfer of information from device to device, in this situation allowing the “master” device that has data and/or audio files to send a wireless signal that will be securely received by the “slave” device (the Bluetooth device within the risers 24) and then is passed along to a digital audio amplifier mounted to digital amplifier board 46 (the Bluetooth chip 51 used on board 50 is Model No. ABI512 manufactured by Airoha Technology, Taipei, Taiwan).

Support Pillars 52, four of which exist within casing 60, that provides additional support for skateboard assembly 10 so that it is able to withstand impacts that are common in skateboarding, as well as to provide a place for the skateboard mounting hardware to pass through when installing and securing riser 24 onto skateboard deck 12.

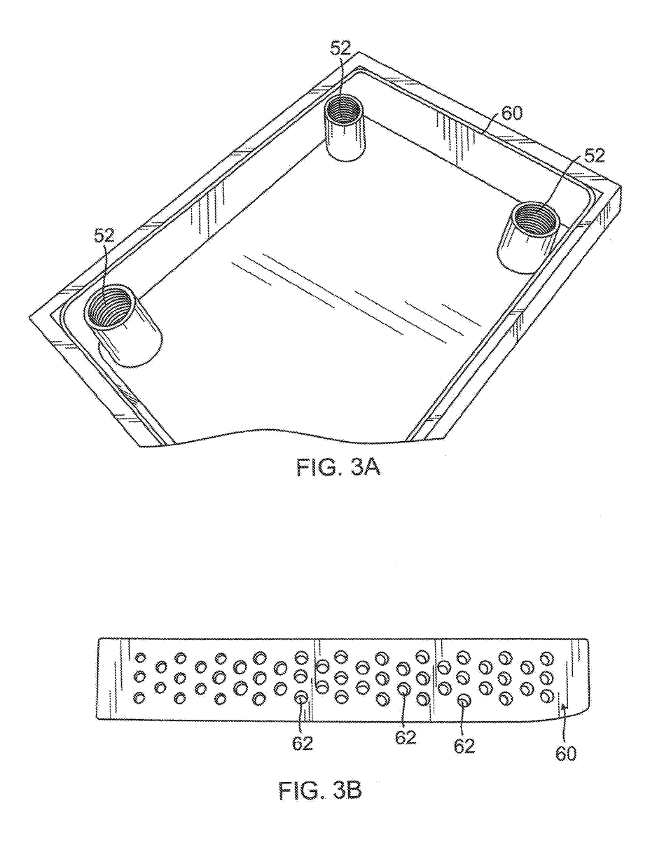

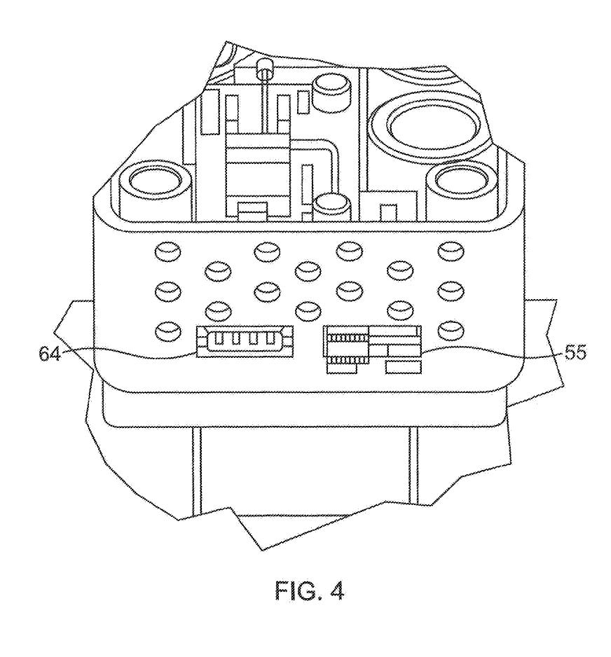

Case 60 is the housing for riser 24 and functions to contain, enclose, and protect all of the components that make up the riser 24, as well as providing the skateboard assembly 10 with an additional height increase, or distance between the wheels and the deck 12, as per the function of a standard skateboard riser. Case 60 is made of a impact resistant material in order to withstand the common impacts and stress resulting from skateboarding and is of an audio-permeable design. The case is preferably made from ABS plastic in order to avoid interference with performance of the skateboard assembly 10 as well as appearing similar to that of risers and skateboards that currently exist. The design of the present invention also contains through-hole 62 (FIG. 3B) on each side of the case 60 in order to allow an uninterrupted audio signal to be emitted. Riser 26 can also be made from an assortment of other materials such as polycarbonate, aluminum, titanium, carbon fiber, etc. and varying design specifics such as the exact dimensions, additional support material within, aesthetic design, feature a removable battery, after the characteristic allowing for audio permeability (i.e. do something other than holes through the walls), etc.

Speaker Wire 56 carries information/frequencies from the digital amplifier board 46 to the speakers 40.

Mini USB Female Socket 64 allows for the connection of a standard Mini USB type cable to charge the lithium battery 42.

Power Switch 55 functions to create a complete or incomplete circuit for the device, which enables it to be “powered-on” or “powered-off”. When in the “on” position, the circuit is complete, and charge freely flows from the battery through the rest of the components allowing the riser assembly to function. When in the “off” position, the circuit is incomplete, preventing the current stored in the battery from flowing through the rest of the components, the riser assembly thus being unable to function and allowing the battery to store charge for use at a later time at the discretion of the skateboard rider.

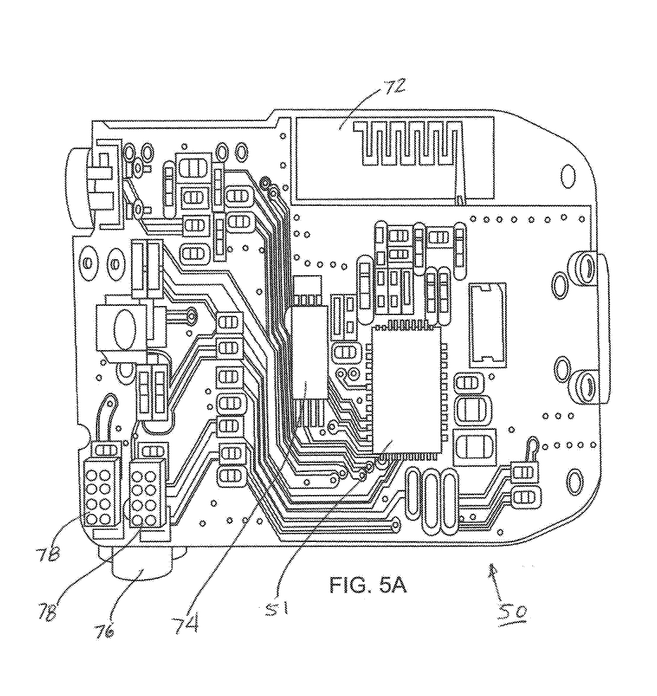

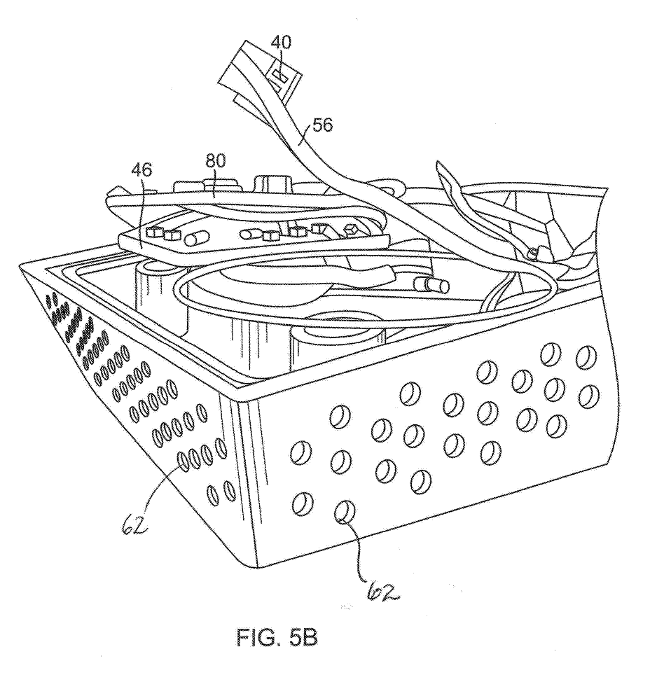

The Bluetooth transceiver as shown in FIG. 5A is connected to the digital amplifier board 46 by three electrical wires that run from the right channel audio output, left channel audio output, and audio ground output connections on the Bluetooth transceiver board 50 and connect to the respective input connections on the digital amplifier board 46. These wires are responsible for the transfer of audio information/signal that has been received by the Bluetooth module, to the digital amplifier board to be analyzed and outputted to the speakers. The Bluetooth transceiver is also connected to the battery as a power source via power/electrical wiring through a standard +/− connection. This connection is interrupted by the installation of a power switch though, so that a switch is wired in series with the negative/ground wire lead resulting in an ability to open/close the switch which in turn opens/closes the circuit either providing power to the Bluetooth transceiver, or not.

The specific components mounted to the Bluetooth transceiver board 50 includes microprocessor 70, Bluetooth chip 51, Bluetooth antenna 72, Electronically erasable and programmable read only memory (EEPROM chip) 74, auxiliary output 76 which is hand-wired to amplifier board 46 and low-dropout regulator (LDO chips) 78.

The Bluetooth transceiver board 50 is mounted alongside the other circuit board modules within the device, and is secured by the use of an adhesive thus enabling a connection to share information with any other device containing an appropriate Bluetooth module as noted hereinabove (FIG. 5B).

FIG. 5B shows another view of the riser internal components and includes amplifier board 46, charging module 80, speaker 40 and speaker wiring 56. The speaker wiring 56, comprising three wires, connects the Bluetooth transceiver to amplifier 46.

Each of the above-noted components have their own PCB which contains all the circuitry and connections that allow the various chips to function and transfer information as necessary.

It should be noted that the Bluetooth transceiver can be incorporated included in a single PCB which incorporates all the chips (amplifier, charger, Bluetooth, etc.) and circuitry necessary to provide the communication feature noted hereinabove. The board 50 is mounted within the device case/housing in a manner that conforms to its unique shape/design while following general practices such as the case containing several small pillars that line up with mounting holes on the circuit board and allow it to be secured to the case in a safe manner. The case is designed to specifically fit all of the components that form the Bluetooth arrangement of the present invention in order to secure and protect the components.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A skateboard having a deck with upper and lower surfaces and at least one truck assembly comprising:
at least one riser mounted to said lower surface of said skateboard;
said riser having an opening to receive an electronic device; and
a Bluetooth speaker transceiver positioned within said riser opening.

2. The skateboard of claim 1 further including a speaker assembly positioned within said riser opening.

3. The skateboard of claim 2 wherein said transceiver is coupled to said speaker assembly in one mode of operation whereby the aural output from said speaker assembly is heard by persons within the broadcast range thereof.

4. The skateboard of claim 2 wherein a skateboard user receives data directly from the Bluetooth speaker transceiver.

5. The skateboard of claim 4 wherein headphones worn by a user receives said data.
